(19) United States
(12) Patent Application Publication
(10) Pub. No.: US 2021/0264719 A1
(43) Pub. Date: Aug. 26, 2021

(54) Instant Game Ticket with Rotatable Game Grid

(71) Applicant: Kathleen Nylund Jackson, Newport, NC (US)

(72) Inventor: Kathleen Nylund Jackson, Newport, NC (US)

(21) Appl. No.: 17/108,299

(22) Filed: Dec. 1, 2020

(51) Int. Cl. G07F 17/32; A63F 3/06

(52) U.S. Cl. CPC G07F 17/329; G07F 17/3209; G07F 17/3244; A63F 3/0665

(57) ABSTRACT

A method of playing a lottery instant scratch ticket and game that provides a rectangular game grid in a first directional mode that is readable from left to right. Three additional possible directional modes are concealed by an opaque removable film. If the game grid provides a win according to the first directional mode and a predetermined paytable, a prize is awarded. The said three additional possible directional modes are then revealed, revealing one, two or three directional modes. The ticket is rotated 90°, 180° or 270° so that any revealed directional mode becomes readable from left to right. If the now-rotated game grid provides a win according to any additional directional mode and the predetermined paytable, a prize is awarded.

### RELATED APPLICATION DATA

This application claims priority from U.S. Provisional Patent Application Ser. No. 62/947,126, filed Dec. 12, 2019, and having the Title INSTANT GAME TICKET WITH ROTATABLE GAME GRID.

### BACKGROUND OF THE INVENTION

### 1. Field of the Invention

The present invention relates to an instant game ticket (otherwise known in the art as a “scratch ticket”). The invention further relates to lottery gaming wherein the physical instant game ticket may be purchased and verified at a lottery agent location or other suitable locations, the ticket utilizing a gameplay that provides a chance to change the direction of the game grid on the ticket. An electronic version is also disclosed.

### 2. Background of the Art

For over 50 years, instant game tickets, or scratch tickets as in known in the art, have been offered for sale as part of city, state, and national lotteries. These tickets typically have an array of winning numbers and an array of player numbers, each concealed with a removable film. The player scratches off the film to reveal the numbers. If a player number matches a winning number, a prize is won.

Scratch ticket games are provided wherein a predetermined number of tickets are printed, each ticket providing either a losing result or a winning result. The amount of tickets with losing results is predetermined, as are the number of tickets with winning results. Also predetermined is the number of tickets for each individual win amount. The total amount of awards of the winning tickets will be less than the total cost of all tickets in the game. For instance, a total of 90,720,000 $5 tickets may be printed and sold. The total ticket sales will be $453,600,000. The total payout to players may be $345,471,000.

Scratch tickets (otherwise known as instant tickets or scratchers) have gained considerable popularity since they provide a near instant gratification; that is, the result can be determined in mere seconds. Extended play tickets provide games that require matching an array of player numbers to corresponding numbers in a game grid, thus increasing gameplay time. A sizeable amount of loyal players prefer the longer gameplay in such extended play tickets as crossword or bingo, where the ticket may take up to five minutes to scratch and complete.

In order to keep the incentive to play fresh and appealing, new versions of the instant ticket have been created. Various attempts have been made to create new instant games and gameplay in order to increase player participation and excitement.

U.S. Pat. No. 7,980,559 (Miller, et al.) discloses a lottery ticket having a play area containing rows and columns defining individual play spaces with up to all of the play spaces containing a play symbol and at least one line connecting a plurality of play spaces wherein a prize may be won if the line connects at least two preselected play symbols.

U.S. Pat. No. 7,959,188 (Martineck, Sr.) describes a scratch off lottery game card that includes a substrate on which a plurality of game indicia are printed on a game indicia area in an M.times.N matrix and a plurality of player indicia are printed on a player indicia area. The game indicia are preferably grouped by different identifier. If the game identified by an identifier have matched to the player indicia, the player wins a prize.

U.S. Pat. No. 6,761,633 (Riendeau, et al.) teaches an online game of chance and methods of conducting and playing the game on a virtual instant ticket. The game is based on a map having multiple branches and nodes, where a desired path is selected by clicking on the branch or node as play progresses between a starting point and multiple finishing points. Each available branch or node that is selected results in a prize value being increased, decreased, or a token being awarded for later use in the game. In a single player mode, a final prize is awarded to the player.

United States Patent Publication No. 20150325079 (Alsip) describes a gaming platform and system for operating a game of chance wherein a gaming machine is adapted to display randomized motions of a plurality of virtual game pieces, wherein the final resting place, orientation and content of each game piece is indeterminate and unknowable until motion stops. The instructions, when executed by a processor, are configured to operate a game of chance. In preferred “conceal and reveal games”, a player selects game pieces, termed here “selectable objects”, each selectable object having a concealed “embedded element” that is revealed during gameplay, and the game outcome is based on the number of random and non-random indicia matched by the player.

United States Patent Publication No. 20110281637 (Meyer, et al.) discloses a lottery ticket having a grid of uniquely identifiable positions displayed thereon. The grid on each ticket is randomly populated with indicia from a field of indicia such that the grid positions contain at least one indicia and the entire field of indicia is randomly populated into each grid. A set of player indicia is indicted on each lottery ticket, which may be randomly generated or selected by the player. The positions in the grid are randomly and sequentially drawn, and the sequential order in which the positions were drawn is provided to the players. Prizes are determined for winning lottery tickets as a function of the number of the grid positions sequentially and randomly drawn prior to matching all of the player indicia on the respective lottery ticket.

Each of the references discussed in this text art are incorporated herein in their entirety for all purposes.

It is an ever-increasing challenge to provide players with new and enticing gameplay features that will stimulate player interest and increase participation in instant lottery games. It would be advantageous to provide inventive elements for an instant scratch ticket that provide additional chances to win.

### SUMMARY OF THE INVENTION

The present invention discloses a method of playing a lottery instant scratch ticket game comprised of a plurality of physical tickets, in which each ticket provides a rectangular game grid associated with a first directional mode that is readable from left to right. Three additional possible directional modes are concealed by an opaque removable film. If the game grid provides a win according to the first directional mode and a predetermined paytable, a prize is awarded. The said three additional possible directional modes are then revealed by scratching off the opaque removable film, so that one, two or three directional modes are revealed. The ticket is rotated 90°, 180° and/or 270° so that any revealed directional mode becomes readable from left to right and may provide additional prizes if its associated game grid provides a win.

### BRIEF DESCRIPTION OF THE FIGURES

FIG. 1A shows an instant scratch ticket comprising elements that are provided on the ticket card utilizing the gameplay described in a first preferred embodiment of the present invention herein.

FIG. 1B refers to FIG. 1A and shows the final individualized ticket.

FIG. 1C refers to FIG. 1B and shows the ticket having been scratched to show the pertinent elements of a first part of the gameplay.

FIG. 1D refers to FIG. 1C and shows additional elements of the gameplay.

FIG. 1E refers to FIG. 1D and shows the ticket being rotated according to one of the additional elements.

FIG. 1F refers to FIG. 1D and shows the ticket again being rotated according to another of the additional elements.

### DETAILED DESCRIPTION OF THE INVENTION

A first preferred embodiment of the present invention describes an instant lottery ticket and method of conducting a lottery instant scratch ticket game that comprises: a) providing a plurality of physical scratch tickets; b) providing a rectangular game grid comprising a predetermined amount of rows and columns, wherein each intersection of a row and a column comprises a play symbol box; c) providing one play symbol in each play symbol box from a predetermined set of play symbols; d) concealing the play symbol in each play symbol box with an opaque removable film; e) providing a unique marking symbol from a predetermined set of unique marking symbols associated with each of the play spaces; f) providing a player symbol box comprising a predetermined amount of marking symbols from the predetermined set of marking symbols as player symbols; g) concealing the player symbol box with a removable opaque film; h) providing instructions on how to play; i) providing a directional symbol box either below or above the game grid; j) providing a directional arrow symbol that points from left to right and that is displayed within the directional symbol box; k) providing an additional directional symbol box adjacent to each of the other three sides of the game grid, each said directional symbol box being concealed by an opaque removable film and each said directional symbol box containing one or none directional arrow symbols; l) removing the opaque film concealing the player symbols to reveal the player symbols; m) removing the opaque film associated with each play symbol box that matches a revealed player symbol so to reveal a play symbol; n) providing a predetermined paytable associated with predetermined amounts of revealed play symbols; o) determining if a predetermined amount of like revealed play symbols reading left-to-right in the game grid and according to the directional symbol within the directional symbol box disposed either below or above the game grid is a win according to the predetermined paytable; p) providing a prize if the said predetermined amount of like revealed play symbols reading left-to-right and according to the directional symbol within the directional symbol box disposed either below or above the game grid is a win according to the predetermined paytable; q) removing the removable opaque film concealing each additional directional symbol box to reveal the either none or one directional arrow symbols; r) rotating the game grid 90°, 180° and/or 270° until a revealed directional arrow is disposed either below or above the game grid and points from left to right; s) determining if a predetermined amount of like revealed play symbols reading left-to-right in the rotated game grid associated with the said revealed directional arrow symbol within the rotated directional symbol box disposed either below or above the game grid is a win according to the predetermined paytable; and t) providing a prize if the predetermined amount of like revealed play symbols reading left-to-right in the rotated game grid associated with the said revealed directional arrow symbol within the rotated directional symbol box disposed either below or above the game grid is a win according to the predetermined paytable.

The said first preferred embodiment of the present invention discloses a lottery game in which a plurality of instant scratch tickets is provided. A wager of cash, credits or non-monetary points may be required to play the game. The name of the game is shown on the ticket. Preferably, a printed verification code is provided and is concealed underneath an opaque film. The said verification code provides an encryption that guarantees that the ticket is valid and maintains the authenticity of the instant game ticket. The price of the ticket and instructions on how to play the game are provided. A rectangular game grid comprising a predetermined amount of rows and columns is provided. Preferably the game grid is arranged as 5 rows by 5 columns, comprising 25 play symbol boxes. One unique play symbol from a predetermined set of play symbols (in this example: O, X and [symbol] ) is provided in each of the 25 play symbol spaces. Each of the play symbol boxes in the game grid is concealed with an opaque removable film, and is associated with one unique marking symbol from a set of 25 unique marking symbols, in this example, the numerical symbols 1 through 25. An array of marking symbols from the predetermined set of marking symbols is printed on the ticket card as player symbols and is covered by a removable opaque film. A directional symbol box is displayed either below or above the game grid and a directional arrow symbol that points from left to right is displayed within the directional symbol box. Three additional directional symbol boxes are displayed adjacent to each of the other three sides of the game grid, each said directional symbol box being concealed by an opaque removable film and each said directional symbol box containing one or none directional arrow symbols. The player scratches off the opaque film covering the player symbols to reveal the player symbols. The player then scratches off the corresponding numbered opaque film covering the play symbol boxes to reveal the game symbols. A predetermined paytable associated with predetermined amounts of revealed play symbols is provided. In this example, three, four and five like play symbols reading from left to right in the game grid provide a win. Referring to the above play symbols (O, X and [symbol] ), this provides nine different wins that are common payouts on a typical scratch card (on a $5 ticket: $5, $10, $20, $40, $50, $100, $500, $1000 and $300,000, for example). If a predetermined amount of like revealed play symbols reading left-to-right and according to the directional symbol within the directional symbol box disposed either below or above the game grid is a win according to the predetermined paytable, a prize is awarded. The removable opaque film concealing each additional directional symbol box is then removed to reveal the either one or none directional arrow symbols. The ticket is then rotated 90°, 180° and/or 270° so that a revealed directional arrow is disposed either below or above the game grid and that points from left to right. If a predetermined amount of like revealed play symbols in the rotated game grid reading left-to-right and according to the directional arrow symbol within the rotated directional symbol box disposed either below or above the game grid is a win according to the predetermined paytable, a prize is awarded. It should be appreciated that no directional arrows may be revealed in the additional directional boxes, one directional arrow may be revealed in one additional directional box, one directional arrow may be revealed in two additional directional boxes or one directional arrow may be revealed in all three additional directional boxes. Any winning ticket (according to the verification code) is then reverified by processing the ticket through a computer terminal comprising at least a ticket input device and a computer processor at a lottery agent location or other suitable locations.

A second preferred embodiment of the present invention discloses an electronic ticket and method of conducting a game that provides an electronic lottery-type ticket displayed on an electronic device that comprises at least a monitor screen, at least an electronic processor, and at least one physical input device, that comprises: a) providing a plurality of virtual scratch tickets; b) providing a rectangular game grid comprising a predetermined amount of rows and columns, wherein each intersection of a row and a column comprises a play symbol box; c) providing one play symbol in each play symbol box from a predetermined set of play symbols; d) concealing each play symbol box in the game grid with a removable layer; e) providing a unique marking symbol from a predetermined set of unique marking symbols associated with each of the play symbol boxes; f) providing a player symbol box comprising a predetermined amount of marking symbols from the predetermined set of marking symbols as player symbols; g) concealing the player symbol box with an opaque removable opaque layer; h) providing instructions on how to play; i) providing a directional symbol box either below or above the game grid; j) providing a directional arrow symbol that points from left to right and that is displayed within the directional symbol box; k) providing an additional directional symbol box adjacent to each of the other three sides of the game grid, each said directional symbol box being concealed by an opaque removable layer and each said directional symbol box containing one or none directional arrow symbols; l) removing the opaque layer concealing the player symbols to reveal the player symbols; m) removing the opaque layer concealing each play symbol box that matches a revealed player symbol so to reveal a play symbol; n) providing a predetermined paytable associated with predetermined amounts of revealed play symbols; o) determining if a predetermined amount of like revealed play symbols reading left-to-right and according to the directional symbol within the directional symbol box disposed either below or above the game grid is a win according to the predetermined paytable; p) providing a prize if the said predetermined amount of like revealed play symbols reading left-to-right and according to the directional symbol within the directional symbol box disposed either below or above the game grid is a win according to the predetermined paytable; q) removing the removable opaque layer concealing each additional directional symbol box to reveal the either none or one directional arrow symbols; r) rotating the game grid 90°, 180° and/or 270° until a revealed directional arrow is disposed either below or above the game grid and points from left to right; s) determining if a predetermined amount of like revealed play symbols reading left-to-right in the rotated game grid associated with the said revealed directional arrow symbol within the rotated directional symbol box disposed either below or above the game grid is a win according to the predetermined paytable; and t) providing a prize if the predetermined amount of like revealed play symbols reading left-to-right in the rotated game grid associated with the said revealed directional arrow symbol within the rotated directional symbol box disposed either below or above the game grid is a win according to the predetermined paytable. The player may remove any layer by utilizing an input device such as a touchscreen, mouse, button or similar tool. Alternately, the processor may function to remove any layer without player input.

Reference to the Figures will assist in further understanding of the practice of the present invention.

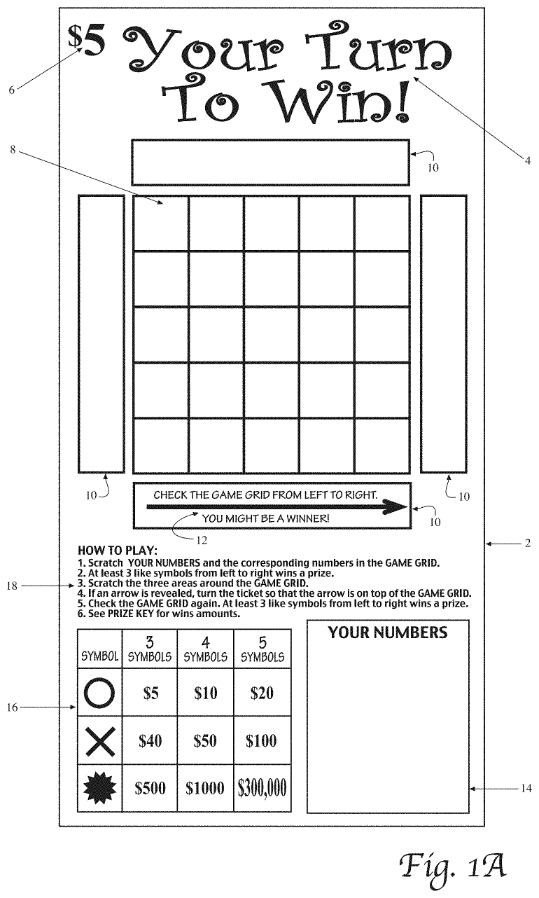

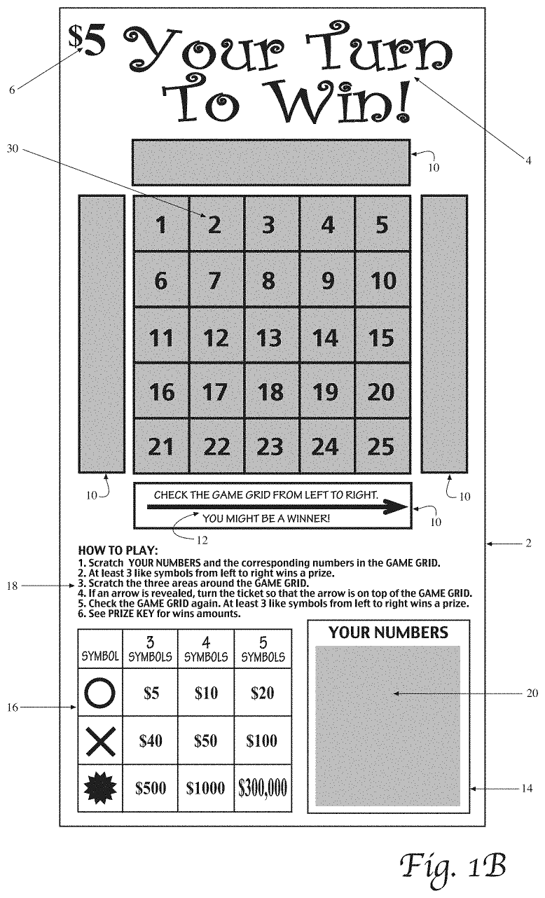

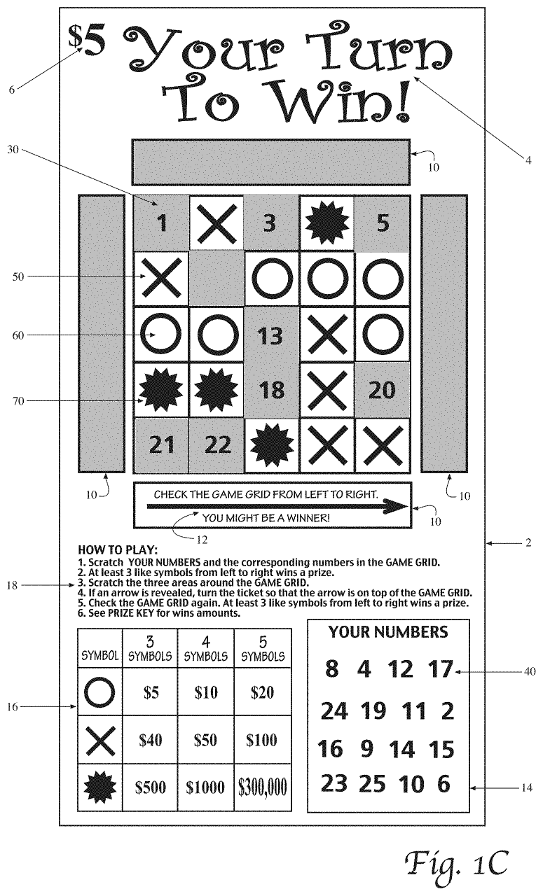

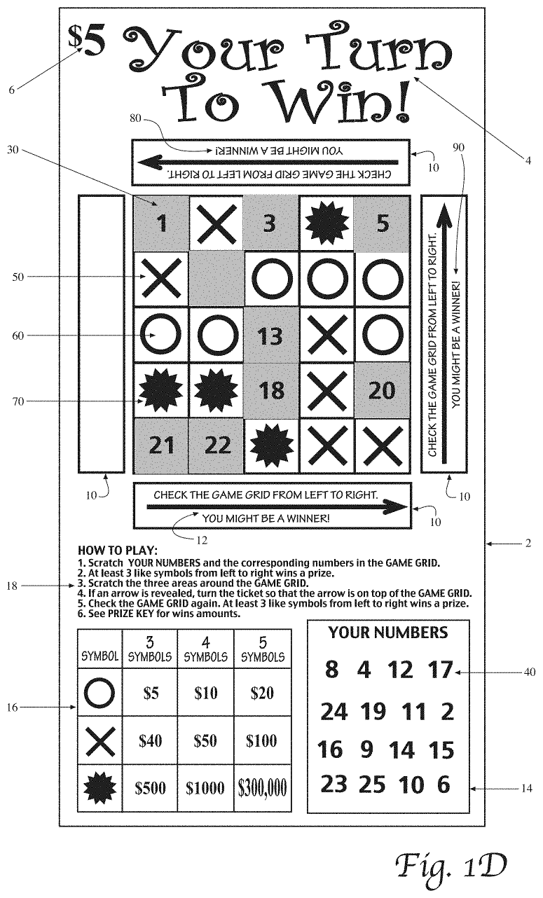

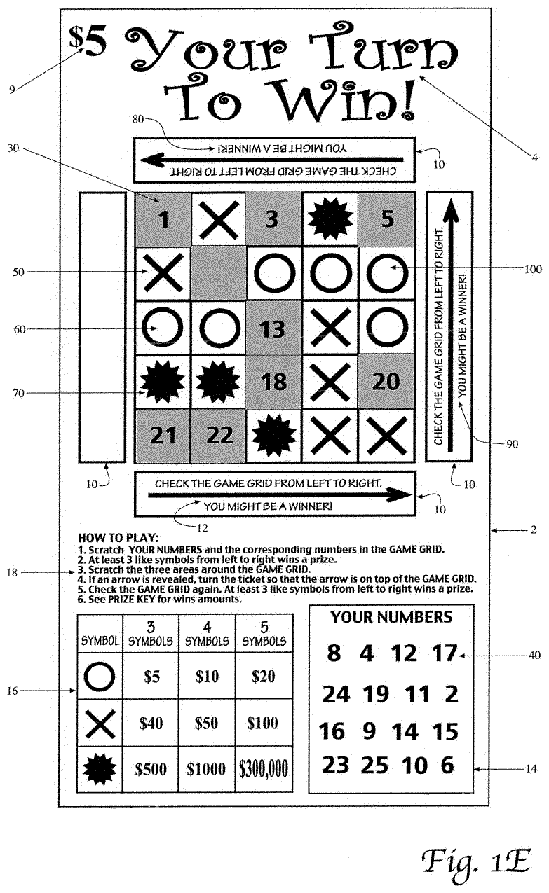

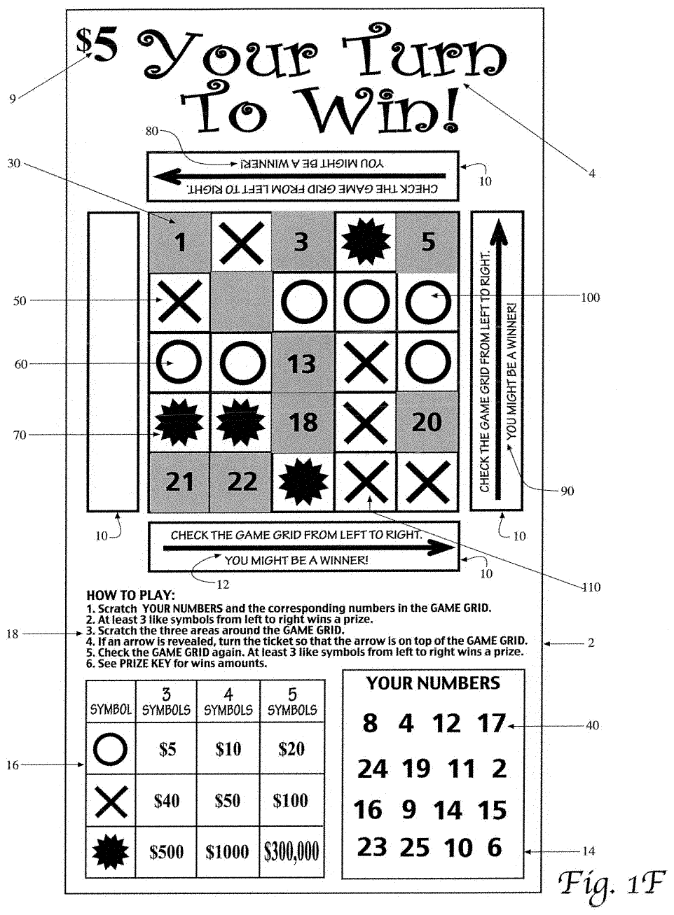

FIG. 1A illustrates the first preferred embodiment of the present invention, providing the elements of present invention that afford the specific gameplay thereof. A physical lottery instant game ticket 2 is provided, the base game card comprising a game ticket name 4, and a price point 6. A game grid 8 is provided, comprising five rows by five columns creating twenty-five play symbol spaces. Four directional symbol boxes 10 are provided, wherein each directional symbol box is disposed adjoining one side of the game grid. The directional symbol box 10 disposed directly below the game grid comprises a directional arrow pointing left to right 12. A player symbol box 14 labeled “YOUR NUMBERS” is shown, as well as a prize legend 16. “How to Play” gameplay instructions 18 are also shown.

FIG. 1B refers to the elements of FIG. 1A wherein the lottery ticket has been individualized. Player numbers (not shown) in the player symbol box 14 have been concealed by an opaque removable film 20. Play symbols (not shown) in each of the play symbol boxes and each of the directional symbol boxes have been concealed by an opaque removable film, each of the play symbol boxes being labeled by a unique number (from 1 to 25) 30.

FIG. 1C refers to the elements of FIG. 1B wherein the player numbers 40 have been revealed by scratching off the opaque film. The opaque film concealing each labeled play symbol box has been removed wherein the number of the play symbol box matches a player number. Sixteen play symbols from a set of play symbols (X 50, O 60 and [symbol] 70) have been revealed. Following the directional arrow 12, and reading the play symbols in rows from left to right, there are no wins according to the prize legend 16.

FIG. 1D refers to the elements of FIG. 1C wherein the opaque film concealing each of the three directional symbol boxes 10 has been removed to reveal two directional arrows (80 and 90).

FIG. 1E refers to the elements of FIG. 1D wherein the lottery ticket 2 has been rotated 180° so that the directional arrow 80 points from left to right and is disposed below the game grid. The play symbols are reviewed again for any wins, and now there are three O symbols 100 that read from left to right. According to the prize legend 16, the win is $5.

FIG. 1F refers to the elements of FIG. 1D wherein the lottery ticket 2 has again been rotated (this time 270°) so that the directional arrow 90 points from left to right and is disposed below the game grid. The play symbols are reviewed again for any wins, and now there are three X symbols 110 that read from left to right. According to the prize legend 16, the win is $40. The total win for the lottery ticket is therefore $45.

Although specific examples and specific win tables have been provided in this discussion, these specifics are intended to be only support for the generic concepts of the invention and are not intended to be absolute limits in the scope of the technology discussed.

What is claimed:

1. An instant ticket and method of conducting a lottery instant scratch ticket game that comprises:
a) providing a plurality of physical scratch tickets;
b) providing a rectangular game grid comprising a predetermined amount of rows and columns, wherein each intersection of a row and a column comprises a play symbol box;
c) providing one play symbol in each play symbol box from a predetermined set of play symbols;
d) concealing the play symbol in each play symbol box with an opaque removable film;
e) providing a unique marking symbol from a predetermined set of unique marking symbols associated with each of the play spaces;
f) providing a player symbol box comprising a predetermined amount of marking symbols from the predetermined set of marking symbols as player symbols;
g) concealing the player symbol box with a removable opaque film;
h) providing instructions on how to play;
i) providing a directional symbol box either below or above the game grid;
j) providing a directional arrow symbol that points from left to right and that is displayed within the directional symbol box;
k) providing an additional directional symbol box adjacent to each of the other three sides of the game grid, each said directional symbol box being concealed by an opaque removable film and each said directional symbol box containing one or none directional arrow symbols;
l) removing the opaque film concealing the player symbols to reveal the player symbols;
m) removing the opaque film associated with each play symbol box that matches a revealed player symbol so to reveal a play symbol;
n) providing a predetermined paytable associated with predetermined amounts of revealed play symbols;
o) determining if a predetermined amount of like revealed play symbols reading left-to-right and according to the directional symbol within the directional symbol box disposed either below or above the game grid is a win according to the predetermined paytable;
p) providing a prize if the said predetermined amount of like revealed play symbols reading left-to-right and according to the directional symbol within the directional symbol box disposed either below or above the game grid is a win according to the predetermined paytable;
q) removing the removable opaque film concealing each additional directional symbol box to reveal the either none or one directional arrow symbols;
r) rotating the game grid 90°, 180° and/or 270° until a revealed directional arrow is disposed either below or above the game grid and points from left to right;
s) determining if a predetermined amount of like revealed play symbols reading left-to-right in the rotated game grid associated with the said revealed directional arrow symbol within the rotated directional symbol box disposed either below or above the game grid is a win according to the predetermined paytable; and
t) providing a prize if the predetermined amount of like revealed play symbols reading left-to-right in the rotated game grid associated with the said revealed directional arrow symbol within the rotated directional symbol box disposed either below or above the game grid is a win according to the predetermined paytable.

2. An electronic ticket and method of conducting a game that provides an electronic lottery-type ticket displayed on an electronic device that comprises at least a monitor screen, at least an electronic processor, and at least one physical input device, that comprises:
a) providing a plurality of virtual scratch tickets;
b) providing a rectangular game grid comprising a predetermined amount of rows and columns, wherein each intersection of a row and a column comprises a play symbol box;
c) providing one play symbol in each play symbol box from a predetermined set of play symbols;
d) concealing each play symbol box in the game grid with a removable layer;
e) providing a unique marking symbol from a predetermined set of unique marking symbols associated with each of the play symbol boxes;
f) providing a player symbol box comprising a predetermined amount of marking symbols from the predetermined set of marking symbols as player symbols;
g) concealing the player symbol box with an opaque removable opaque layer;
h) providing instructions on how to play;
i) providing a directional symbol box either below or above the game grid;
j) providing a directional arrow symbol that points from left to right and that is displayed within the directional symbol box;
k) providing an additional directional symbol box adjacent to each of the other three sides of the game grid, each said directional symbol box being concealed by an opaque removable layer and each said directional symbol box containing one or none directional arrow symbols;
l) removing the opaque layer concealing the player symbols to reveal the player symbols;
m) removing the opaque layer concealing each play symbol box that matches a revealed player symbol so to reveal a play symbol;
n) providing a predetermined paytable associated with predetermined amounts of revealed play symbols;
o) determining if a predetermined amount of like revealed play symbols reading left-to-right and according to the directional symbol within the directional symbol box disposed either below or above the game grid is a win according to the predetermined paytable;
p) providing a prize if the said predetermined amount of like revealed play symbols reading left-to-right and according to the directional symbol within the directional symbol box disposed either below or above the game grid is a win according to the predetermined paytable;
q) removing the removable opaque layer concealing each additional directional symbol box to reveal the either none or one directional arrow symbols;
r) rotating the game grid 90°, 180° and/or 270° until a revealed directional arrow is disposed either below or above the game grid and points from left to right;
s) determining if a predetermined amount of like revealed play symbols reading left-to-right in the rotated game grid associated with the said revealed directional arrow symbol within the rotated directional symbol box disposed either below or above the game grid is a win according to the predetermined paytable; and
t) providing a prize if the predetermined amount of like revealed play symbols reading left-to-right in the rotated game grid associated with the said revealed directional arrow symbol within the rotated directional symbol box disposed either below or above the game grid is a win according to the predetermined paytable.

3. The method of claim 2 wherein the player may remove any layer by utilizing an input device such as a touchscreen, mouse, button or similar tool.

4. The method of claim 2 wherein the processor may function to remove any layer without player input.
